(19) United States
(12) Patent Application Publication
(10) Pub. No.: US 2025/0384199 A1
(43) Pub. Date: Dec. 18, 2025

(54) SYSTEMS AND METHODS FOR GENERATING DASHBOARDS FROM IMAGES

(71) Applicant: PwC Product Sales LLC, New York, NY (US)

(72) Inventors: Gaurav KUMAR, Karnataka (IN); Kanak DAHAKE, Maharashtra (IN); Chakkarapani VIJAYAKUMAR, Chennai (IN); Saurabh MOHANTY, Los Gatos, CA (US); Joseph David VOYLES, Louisville, KY (US); Md Mustafizur RAHMAN, North Lauderdale, FL (US)

(73) Assignee: PwC Product Sales LLC, New York, NY (US)

(21) Appl. No.: 18/741,566

(22) Filed: Jun. 12, 2024

(51) Int. Cl. G06F 40/103; G06V 20/60; G06V 20/70; G06V 30/18; G06V 30/19; G06V 30/413; G06V 30/416; G06V 30/42

(52) U.S. Cl. CPC G06F 40/103; G06V 20/60; G06V 20/70; G06V 30/1801; G06V 30/18105; G06V 30/19013; G06V 30/413; G06V 30/416; G06V 30/42

(57) ABSTRACT

A method for generating a dashboard from an image, the method comprises: receiving an image of at least part of a first dashboard generated using a first dashboard platform; applying an object detection model to the image to detect a chart in the image; extracting a portion of the image comprising the chart; applying a classification model to the extracted portion of the image to classify the chart; applying an optical character recognition model to the extracted portion of the image to generate one or more text instances based on the extracted portion; labeling the one or more text instances; applying a matching algorithm based on the one or more labeled text instances to match to text strings in a database; and providing instructions for a second dashboard platform to generate a second dashboard based on data corresponding to the text strings in the database.

### FIELD

The present disclosure relates generally to generating dashboards and more specifically to systems and methods for generating dashboards from images.

### BACKGROUND

Many organizations use dashboards to visualize and analyze data. Dashboards can be generated using various platforms, and organizations may switch between different dashboard platforms for different use cases, different projects, or when organizational changes regarding data visualization, cost, and/or technology requirements are implemented. However, transferring information from one dashboard platform to another may be challenging because different dashboard platforms are often incompatible with one another.

As a result, switching from one dashboard platform to another currently requires a user to manually recreate an existing dashboard in the new dashboard platform. Manually recreating dashboards can be time consuming and error prone. Alternatively, an existing dashboard can be transferred to a new dashboard platform by transforming the information in the dashboard into a format that can be ingested by the new dashboard (e.g., an Excel file). However, this solution is also inefficient because it requires converting the dashboard into an intermediate format before it can be recreated.

### SUMMARY

As described above, transferring information from one dashboard platform to another can be challenging. Accordingly, there is a need for improved systems and methods for efficiently, accurately, and quickly extracting information from existing images of dashboard information and automatically using the extracted data to generate a new dashboard on a new dashboard platform, thus effectively allowing for “converting” of dashboards from an existing dashboard platform to a new dashboard platform.

Described herein are systems and methods for generating dashboards from images, which may address the above-identified need. The systems and methods described herein leverage various machine learning techniques and algorithms to convert an image of a dashboard generated using a first dashboard platform into a functional dashboard in a second (different) dashboard platform.

An exemplary method includes receiving an image of at least part of a first dashboard generated using a first dashboard platform. The dashboard may include one or more charts. An object detection model may be applied to the image to detect a chart in the image. A portion of the image that includes the chart may be extracted, and a classification model may be applied to the extracted portion of the image to classify the chart (e.g., as a bar chart, line chart, or pie chart). An optical character recognition model may then be applied to the extracted portion of the image to generate one or more text instances from the chart based on the extracted portion. The one or more text instances may subsequently be labeled (e.g., as a chart title, an x-axis title, a y-axis title, etc.). A matching algorithm may be applied based on the one or more labeled text instances to match to text strings in a database, which may be the database that was used to create the first dashboard depicted in the image. The matching algorithm may be applied directly to the one or more labeled text instances and/or to one or more axis titles extracted from or otherwise generated based on a labeled text instance labeled as a chart title using a natural language processing model. Instructions may be provided for a second dashboard platform to generate a second dashboard based on data corresponding to the text strings in the database.

The techniques described herein may provide several technical advantages. The systems and methods provided herein may enable more accurate and efficient recreation of dashboards. As described, existing methods of recreating a dashboard in a new platform may require a user to manually recreate the dashboard or convert the dashboard into an intermediate format, which can be inefficient and/or error-prone. By using various machine learning techniques to detect and recreate the dashboard, the systems and methods described herein may provide more accurate representations of the dashboard in an efficient manner. Furthermore, the systems and methods provided herein may circumvent issues of system incompatibility. Conventionally, a dashboard created using a first dashboard platform may not be recreated using a second dashboard platform unless the dashboard is first converted into a format that is digestible by the second dashboard platform (e.g., an Excel file). The systems and methods provided herein may allow a user to avoid converting the dashboard into an intermediate file format by simply providing an image (e.g., a screenshot) of the dashboard to a dashboard generation engine, which can recreate the dashboard from the image.

In some embodiments, a method for generating a dashboard from an image comprises: receiving an image of at least part of a first dashboard generated using a first dashboard platform; applying an object detection model to the image to detect a chart in the image; extracting a portion of the image comprising the chart; applying a classification model to the extracted portion of the image to classify the chart; applying an optical character recognition model to the extracted portion of the image to generate one or more text instances based on the extracted portion; labeling the one or more text instances; applying a matching algorithm based on the one or more labeled text instances to match to text strings in a database; and providing instructions for a second dashboard platform to generate a second dashboard based on data corresponding to the text strings in the database.

In some embodiments, extracting a portion of the image comprising the chart comprises: applying a contour detection model to the image to detect a boundary of the chart; and extracting a portion of the image comprising an area surrounded by the detected boundary. In some embodiments, the contour detection model is configured to detect a rectangular boundary around the chart. In some embodiments, applying the matching algorithm based on the one or more labeled text instances comprises applying the matching algorithm to the one or more labeled text instances. In some embodiments, applying the matching algorithm based on the one or more labeled text instances comprises: applying a natural language processing model to a labeled text instance labeled as a chart title; receiving, from the natural language processing model, a first extracted text instance corresponding to an x-axis title extracted from the chart title and a second extracted text instance corresponding to a y-axis title extracted from the chart title; and applying the matching algorithm to at least the first extracted text instance and the second extracted text instance. In some embodiments, the method further comprises applying the matching algorithm to one or more additional labeled text instances. In some embodiments, the matching algorithm is configured to: receive an input comprising a labeled text instance or an extracted axis title; calculate, for the input, a plurality of scores, wherein each score indicates a proximity of a match between the input and a respective text string in the database; select a lowest score; and match the input to a first text string corresponding to the lowest score. In some embodiments, the plurality of scores comprise Levenshtein distances. In some embodiments, the image comprises a PNG, JPEG, or PDF file. In some embodiments, the first dashboard comprises data from the database. In some embodiments, the object detection model is configured to detect coordinates of the chart. In some embodiments, the object detection model is trained using a plurality of charts comprising a plurality of chart types. In some embodiments, the classification model is configured to classify the chart as a bar chart, line chart, pie chart, scatter chart, or area chart. In some embodiments, the optical character recognition model is configured to generate text comprising at least one of a chart title, a chart legend, x-axis labels, an x-axis title, y-axis labels, or a y-axis title. In some embodiments, the optical character recognition model is configured to identify coordinates of the generated text. In some embodiments, labeling the one or more text instances comprises: detecting text instances in a top portion of the extracted portion of the image; determining a size of each text instance in the top portion; identifying a first text instance having a largest size in the top portion; and labeling the first text instance as a chart title. In some embodiments, the top portion comprises an upper 30% of the portion of the image. In some embodiments, labeling the one or more text instances comprises: detecting a marker located adjacent to a first text instance; determining that the marker is a different color than a background color of the extracted portion of the image; and labeling the first text instance as a legend. In some embodiments, labeling the one or more text instances comprises: detecting a first plurality of text instances in a bottom portion of the extracted portion of the image; determining that the first plurality of text instances are vertically aligned; and labeling the first plurality of text instances as x-axis labels. In some embodiments, labeling the one or more text instances comprises: detecting a first text instance in a bottom portion of the extracted portion of the image; determining that the first text instance is within a predetermined distance of a center of the extracted portion of the image horizontally; and labeling the first text instance as an x-axis title. In some embodiments, the bottom portion comprises a bottom 30% of the portion of the image. In some embodiments, labeling the one or more text instances comprises: detecting a first plurality of text instances in a left portion of the extracted portion of the image; determining that the first plurality of text instances are horizontally aligned; and labeling the first plurality of text instances as y-axis labels. In some embodiments, labeling the one or more text instances comprises: detecting a first text instance in a left portion of the extracted portion of the image; determining that the first text instance is within a predetermined distance of a center of the extracted portion of the image vertically; and labeling the first text instance as a y-axis title. In some embodiments, the left portion comprises a left 30% of the portion of the image.

In some embodiments, a system for generating a dashboard from an image comprises one or more processors configured to cause the system to perform a method comprising: receiving an image of at least part of a first dashboard generated using a first dashboard platform; applying an object detection model to the image to detect a chart in the image; extracting a portion of the image comprising the chart; applying a classification model to the extracted portion of the image to classify the chart; applying an optical character recognition model to the extracted portion of the image to generate one or more text instances based on the extracted portion; labeling the one or more text instances; applying a matching algorithm based on the one or more labeled text instances to match to text strings in a database; and providing instructions for a second dashboard platform to generate a second dashboard based on data corresponding to the text strings in the database.

In some embodiments, a non-transitory computer-readable storage medium stores instructions that, when executed by one or more processors of an electronic device, cause the device to perform a method comprising: receiving an image of at least part of a first dashboard generated using a first dashboard platform; applying an object detection model to the image to detect a chart in the image; extracting a portion of the image comprising the chart; applying a classification model to the extracted portion of the image to classify the chart; applying an optical character recognition model to the extracted portion of the image to generate one or more text instances based on the extracted portion; labeling the one or more text instances; applying a matching algorithm based on the one or more labeled text instances to match to text strings in a database; and providing instructions for a second dashboard platform to generate a second dashboard based on data corresponding to the text strings in the database.

In some embodiments, any of the features of any of the embodiments described above and/or described elsewhere herein may be combined, in whole or in part, with one another.

Additional advantages will be readily apparent to those skilled in the art from the following detailed description. The aspects and descriptions herein are to be regarded as illustrative in nature and not restrictive.

### BRIEF DESCRIPTION OF THE FIGURES

A better understanding of the features and advantages of the present disclosure will be obtained by reference to the following detailed description that sets forth illustrative embodiments, in which the principles of the disclosure are utilized, and the accompanying drawings of which:

FIG. 1 illustrates an exemplary system for generating a dashboard from an image, according to some embodiments.

FIG. 2 illustrates an exemplary method for generating a dashboard from an image, according to some embodiments.

FIG. 3 illustrates exemplary results of applying a contour detection model, according to some embodiments.

FIG. 4 illustrates exemplary generated text instances, according to some embodiments.

FIG. 5 illustrates an exemplary flowchart of a process for generating a dashboard from an image, according to some embodiments.

FIG. 6 illustrates an exemplary computing system, according to some embodiments.

### DETAILED DESCRIPTION

As described, it can be difficult to convert a dashboard from one dashboard platform to another. Existing solutions for converting a dashboard include manually recreating the dashboard or exporting the information contained in the dashboard in a different format that can be ingested by the new platform, both of which are inefficient and introduce the potential for error.

Accordingly, provided herein are systems and methods for generating a new dashboard from an image of an existing dashboard.

Methods for generating a dashboard from an image may include receiving an image of at least part of a first dashboard generated using a first dashboard platform (e.g., Tableau, PowerBI). The image may be, for example, a screenshot of some or all of a dashboard. An object detection model may be applied to the image to detect a chart in the image. Once a chart has been detected, a portion of the image that includes the chart may be extracted. Optionally, a contour detection model may be used to ascertain the boundaries of the chart before extracting the portion of the image including the chart. A classification model may then be applied to the extracted portion of the image to classify the chart (e.g., as a line chart, bar chart, pie chart, etc.).

An optical character recognition model may be applied to the extracted portion of the image to generate one or more text instances based on the extracted portion of the image. The extracted portion of the image may include text corresponding to chart titles, axis titles, axis labels, or legends. The one or more text instances may then be labeled to indicate the type of text to which they correspond. For example, a labeling algorithm may be applied to each text instance to identify and label the text instance as a chart title, axis title, axis label, or legend.

Optionally, a natural language processing model may be applied to a labeled text instance labeled as a chart title. If the chart title contains one or more axis titles (e.g., if the chart title has the form “y-axis vs. x-axis”), the natural language processing model may extract or otherwise generate the axis title(s) from the labeled text instance labeled as a chart title.

A matching algorithm may be applied based on the one or more labeled text instances to match to text strings in a database. The matching algorithm may be applied to the axis title(s) extracted and/or generated by the natural language processing model and/or to the labeled text instances, including those with labels other than chart title. The database containing the text strings to which the extracted or generated axis titles and/or labeled text instances are matched may include the data used to create the first dashboard depicted in the image. The matching algorithm may perform fuzzy matching to match text instances to text strings in the database that they most closely approximate.

Instructions for generating a dashboard based on data corresponding to the text strings in the database may be provided. The instructions may be provided to a user or directly to a dashboard platform capable of generating a new functional dashboard.

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed terms. It is further to be understood that the terms “includes,” “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes, or it may comprise a general-purpose computer selectively activated or reconfigured by a computer program stored in the computer. Such a computer program may be stored in a non-transitory, storage medium, such as, but not limited to, any type of disk, including floppy disks, USB flash drives, external hard drives, optical disks, CD-ROMs, magneto-optical disks, read-only memories (ROMs), random access memories (RAMs), EPROMs, EEPROMs, magnetic or optical cards, application-specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The structure for a variety of these systems will appear in the description below. In addition, the present invention is not described with reference to any particular programming language. It will be appreciated that a variety of programming languages may be used to implement the teachings of the present disclosure as described herein.

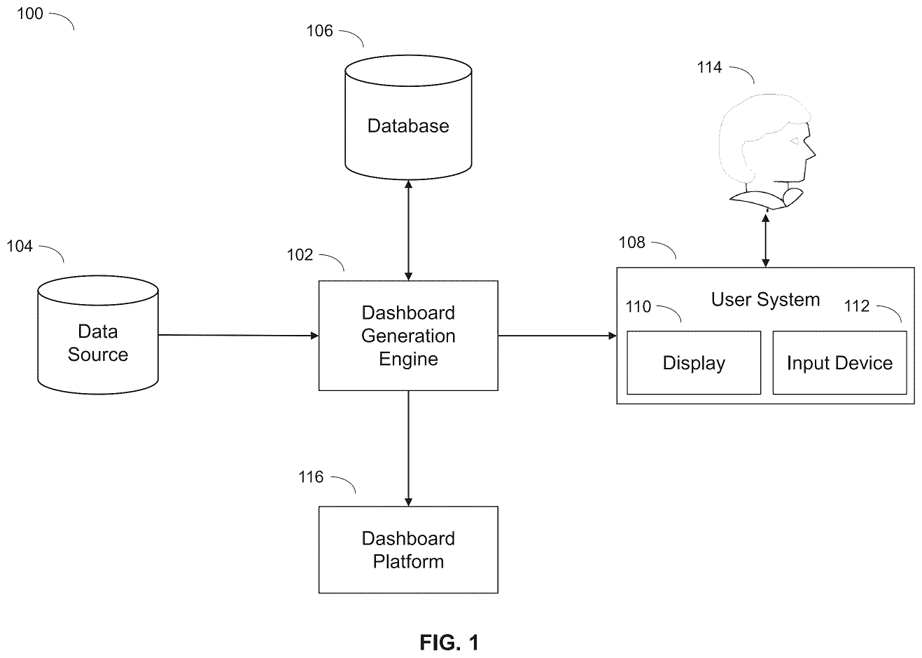

FIG. 1 illustrates an exemplary system for generating dashboards from images. The system 100 may include a dashboard generation engine 102, which may receive images of dashboards from a data source 104. Dashboard generation engine 102 may recreate a dashboard depicted in an image by applying a series of machine learning models and algorithms to detect features of the image and identify data from a database 106 which can be used to recreate the dashboard. System 100 may optionally include a user system 108 including at least a display 110 and an input device 112, which may be used to provide instructions for generating a dashboard to a user 114. System 100 may optionally include a dashboard platform 116. Dashboard generation engine 102 may provide instructions for generating a dashboard directly to dashboard platform 116 instead of or in addition to providing the instructions to user system 108.

Dashboard generation engine 102 may be configured to receive images of dashboards generated using a first dashboard platform (e.g., Tableau, PowerBI) and use them to generate instructions to recreate the dashboard using a second dashboard program different from the first dashboard program. Dashboard generation engine 102 may be provided as software implemented on its own computing system and communicatively connected to one or more components of system 100 or may be implemented on the same computing system as one or more components of system 100.

Dashboard generation engine 102 may be configured to receive images of dashboards from a data source 104. Data source 104 may be provided on the same computing system as dashboard generation engine 102 or may be communicatively coupled to dashboard generation engine 102 via a wired or wireless connection. Data source 104 may be a memory (e.g., random-access memory, a cache, a hard drive, a CD-ROM drive, a tape drive, or a removable storage disk), a computer program used to take images of dashboards (e.g., a program configured to capture screenshots), a server or database that stores images, or a storage device (e.g., a USB drive, hard drive, or storage disk). Dashboard images stored in data source 104 may be JPEGs, PNGs, PDFs, or any other suitable file format.

System 100 may further include a database 106. Database 106 may include the data used to create the original dashboard depicted in the image received from data source 104. For example, database 106 may include data used to populate one or more charts included in the dashboard. Database 106 may be provided on the same computing system as dashboard generation engine 102 or may be provided on a separate computing system that is communicatively coupled to dashboard generation engine 102 via a wired or wireless connection.

System 100 may further include a user system 108. In some embodiments, user system 108 may be included in system 100. In some embodiments, user system 108 may be provided separately from system 100 and communicatively coupled to one or more components of the system (e.g., dashboard generation engine 102) via a wired or wireless connection.

In some embodiments, user system 108 may be communicatively coupled to dashboard generation engine 102, such that user system 108 may receive the instructions generated by dashboard generation engine 102 and provide them to a user 114. To facilitate the provision of instructions to a user 114, user system 108 may include a display 110 (e.g., a computer monitor or a screen) and an input device 112 (e.g., a keyboard, a mouse, or a touch sensor) which a user 114 may use to execute or otherwise interact with the instructions.

Optionally, system 100 may include a dashboard platform 116. In some embodiments, dashboard platform 116 may be included in system 100. In some embodiments, dashboard platform 116 may be provided separately from system 100 and communicatively coupled to one or more components of the system (e.g., dashboard generation engine 102). Dashboard platform 116 may be, for example, Tableau, PowerBI, or any other suitable platform for generating dashboards. Dashboard platform 116 may be configured to receive instructions for generating a dashboard from dashboard generation engine 102 and create a dashboard based on the instructions.

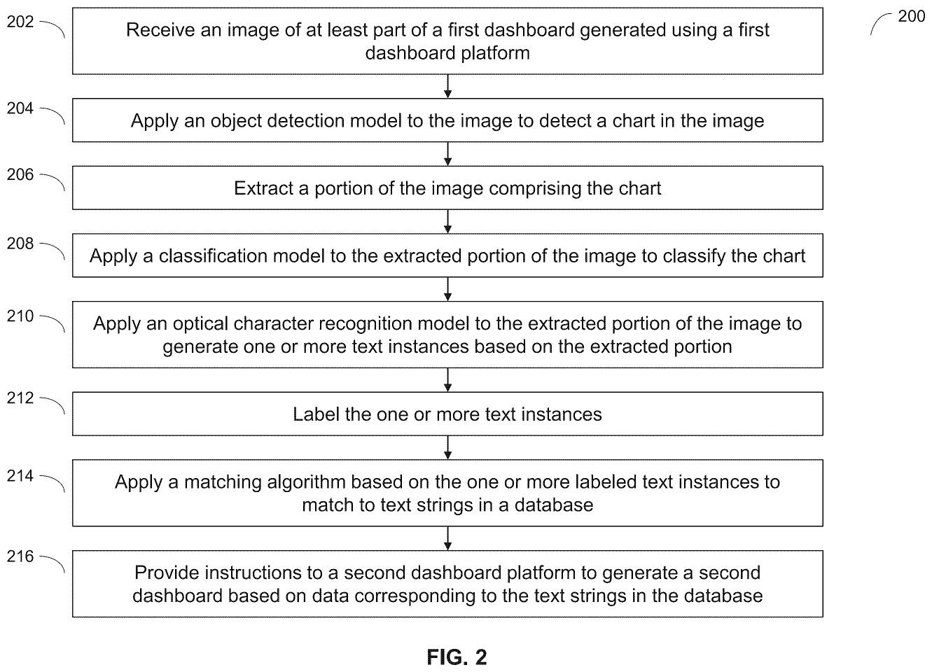

As described, system 100 may be configured to receive an image of a dashboard and generate instructions for recreating the dashboard using a new dashboard platform. FIG. 2 illustrates an exemplary method 200 that may be performed by system 100, according to some embodiments.

Method 200 may be performed, for example, using one or more electronic devices implementing a software platform. In some embodiments, method 200 may be performed using one or more electronic devices. In some embodiments, method 200 may be performed using a client-server system, and the blocks of method 200 may be divided up in any manner between the server and one or more client devices. Thus, while portions of method 200 are described herein as being performed by particular devices, it will be appreciated that method 200 is not so limited. In method 200, some blocks may be optionally, combined; the order of some blocks may be, optionally, changed; and some blocks may be, optionally, omitted. In some embodiments, additional steps may be performed in combination with the method 200. Accordingly, the operations as illustrated (and described in greater detail below) are exemplary by nature and, as such, should not be viewed as limiting.

At step 202, an image of at least part of a first dashboard generated using a first dashboard platform may be received. The image may be received, for example, by dashboard generation engine 102 described above with reference to FIG. 1. The image may be a JPEG, PNG, PDF, or any other suitable file format. In some embodiments, the image may depict all or some of a first dashboard generated using a first dashboard platform. The first dashboard (or portion thereof depicted in the image) may include one or more charts (e.g., line charts, bar charts, pie charts, or any other suitable type of chart). The first dashboard may be generated using a first dashboard platform such as Tableau, PowerBI, Grafana, or any other platform used to create dashboards.

At step 204, an object detection model may be applied to the image to detect a chart in the image. The object detection model may be applied by dashboard generation engine 102. As described, the image of a dashboard received at step 202 may include a chart. In some embodiments, the image may include a plurality of charts. The charts may include line charts, bar charts, pie charts, area charts, scatter charts, or any other type of chart suitable for displaying data. The object detection model may be configured to detect each chart and the coordinates and dimensions (e.g., height and width) of each chart within the image. In some embodiments, the object detection model may detect a chart by identifying borders (e.g., a rectangular bounding box) surrounding the chart.

In some embodiments, the object detection model applied may be an open-source object detection model (e.g., YOLOv5) or may be a model specifically developed to detect charts in images of dashboards. The object detection model may be trained on an extensive data set comprising representative examples of various types of charts. The examples may be generated using various chart generation programs, such that the object detection model can accurately detect charts generated by various dashboard platforms.

At step 206, a portion of the image comprising the chart may be extracted. In some embodiments, the image may depict a dashboard having features other than charts (e.g., text, interactive graphical user interface elements, etc.). The portion of the image comprising the chart may be extracted such that the portion of the image including the chart may be processed separately from the portions of the image including the additional dashboard features.

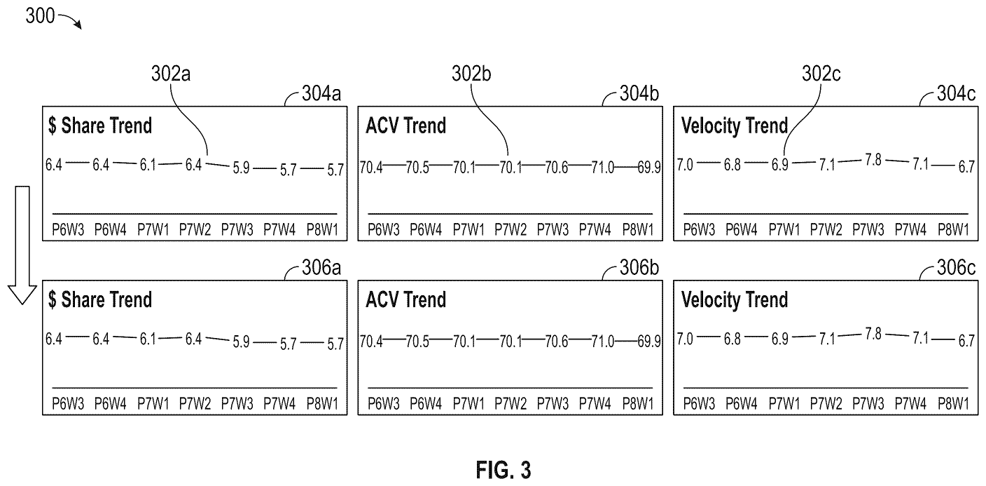

In some embodiments, a contour detection model may be applied to the image prior to extracting the portion of the image comprising the chart. The contour detection model may be configured to identify the boundaries of the chart. In some embodiments, the contour detection model may be configured to detect a rectangular bounding box surrounding the chart. Once the contour detection model has been applied, the portion of the image comprising the chart may then be extracted. Exemplary results of applying a contour detection model are shown in FIG. 3. A portion of the image 300 may include three charts 302a, 302b, and 302c. An object detection model, such as the object detection model applied in step 204, may identify boundaries 304a-c of each chart 302a-c. The boundaries identified by the object detection model may be imprecise. For example, the boundary 304a of chart 302a overlaps with the boundary 304b of chart 302b. A contour detection model may be applied to identify more accurate boundaries 306a-c for each chart. As shown in FIG. 3, boundaries 306a-c are rectangular bounding boxes that encompass the respective charts and do not overlap.

Applying the contour detection model prior to extracting the portion of the image that includes the chart may cause the extracted portion of the image to more precisely reflect the boundaries of the chart. Thus, the input to the downstream processing steps (e.g., the classification model) may be more precise, which can improve the accuracy of the downstream processing steps. In some embodiments, the contour detection model applied may be an open-source contour detection model (e.g., an image processing algorithm such as the Suzuki-Abe Algorithm) or may be a model developed specifically for these purposes.

Returning to FIG. 2, a classification model may be applied to the extracted portion of the image to classify the chart at step 208. The classification model may be applied by dashboard generation engine 102. In some embodiments, the classification model may be an open-source classification model (e.g., VGG-19, ResNetl52V2, InceptionV3, or EfficientNetB3) or may be a model specifically developed for these purposes. The classification model may classify the chart or charts detected by the object detection model by chart type (e.g., line chart, bar chart, pie chart, area chart, scatter chart, etc.). The classification of the chart or charts may be included in the instructions generated by dashboard generation engine 102. The classification may also be used to determine which types of text are present in a chart in the labeling step described in greater detail below.

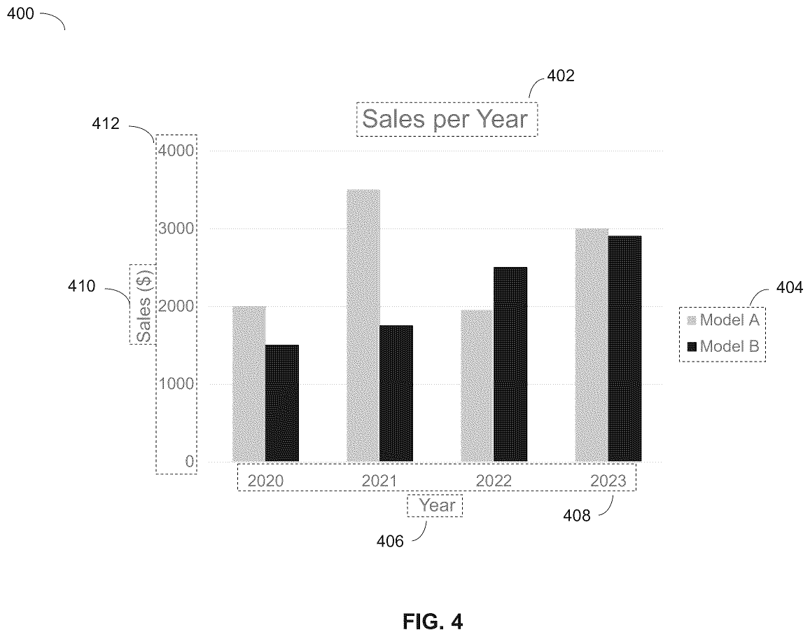

At step 210, an optical character recognition model may be applied to the extracted portion of the image to generate one or more text instances based on the extracted portion. The optical character recognition model may be applied by dashboard generation engine 102. In some embodiments, the optical character recognition may be an open-source optical character recognition model (e.g., Keras OCR or Tesseract) or may be a model specifically developed to recognize text on a chart. The optical character recognition model may be configured to generate text instances and identify their location (e.g., coordinates) in the image. FIG. 4 shows an example of text instances that may be generated based on an image 400 comprising a chart. The chart shown includes a title 402 reading “Sales per Year” and a legend 404 including the text “Model A” and “Model B.” The chart also includes an x-axis title 406 (“Year”) and x-axis labels 408 (“2020,” “2021,” “2022,” “2023”). The chart further includes a y-axis title 410 (“Sales ($)”) and y-axis labels 412 (“0,” “1000,” “2000,” “3000,” “4000”).

In some embodiments, the optical character recognition model may be configured to detect text having any orientation and generate corresponding text instances. For instance, the optical character recognition model may detect text having a conventional horizontal orientation, text having a vertical orientation (e.g., text tilted 90 degrees from the horizontal orientation, such as a y-axis title), or text having any other orientation. In some embodiments, the optical character recognition model may be applied to the extracted portion of the image in its default orientation to detect text having a horizontal orientation. The extracted portion of the image may then be rotated by 90 degrees (clockwise or counterclockwise) to give the extracted portion of the image a second orientation, and the optical character recognition model may be applied again in order to detect text having a vertical orientation.

In some embodiments, intersection over union (IoU) may be calculated for each unique pair of text instances generated by the optical character recognition model from the extracted portion of the image in the first orientation and the second orientation. IoU may be calculated between the pairs of generated text instances in order to ensure that the optical character recognition model does not detect the same text more than once and generate duplicates of any text instances. IoU captures the ratio between the overlapping area of a generated text instance in a first orientation and a generated text instance in a second orientation to the total area covered by the generated text instance in each orientation. Thus, IoU may be calculated using the formula:

$$IoU = \frac{Area of overlap}{Area of union} \qquad ( Equation 1 )$$

In some embodiments, a threshold IoU value may be determined. If the IoU value for a given pair of generated text instances falls below the threshold IoU value, the text instances may be deemed not to be duplicates. However, if the IoU value for a given pair of generated text instances exceeds the threshold IoU value, the orientations of the text instance may be deemed to be duplicates, and the pair of text instances may be compared to determine which text instance to use in downstream processing steps. In some embodiments, the threshold may be about 65-95%, about 75-85%, or about 80%. To determine which generated text instance of a pair of generated text instances to use in downstream processing steps, the aspect ratios of the pair of generated text instances may be compared. An aspect ratio of a given text instance is the ratio of the width of the text instance to the height of the text instance. In some embodiments, the generated text instance having a larger aspect ratio (e.g., ratio of width to height) may be selected for use in downstream processing steps based on the assumption that text instances on a chart typically comprise a single line of text and are therefore wider than they are tall.

At step 212, the one or more text instances generated in step 210 may be labeled. Labels may describe aspects of a chart to which the one or more text instances correspond. As described above with reference to FIG. 4, a text instance may correspond to a chart title, an x or y axis title, an x or y axis label, or a legend. In some embodiments, text instances may be labeled by applying a labeling algorithm. The labeling algorithm may be applied by dashboard generation engine 102.

In some embodiments, the labeling algorithm labels text instances in a predetermined order. For instance, the labeling algorithm may first label a legend, then a title, then x-axis labels, then an x-axis title, then y-axis labels, and finally a y-axis title. Text instances may be labeled in this order because the types of text labeled early in the order (e.g., legend and title) may be present in the most types of charts. For example, pie charts, line charts, and bar charts are all likely to have at least a legend and a title. On the other hand, types of text labeled later in the order (e.g., x and y axis titles) may not be present in every type of chart and thus may not need to be labeled. For instance, a pie chart does not have axes and therefore does not have axis titles or labels.

In some embodiments, the labeling algorithm may label one or more text instances as a legend. The label may be based on whether there is a colored marker located next to the text instance. The algorithm therefore assumes that a legend has a colored marker associated with each text instance corresponding to a unique data set. To label a text instance as a legend, the algorithm may first determine whether there is a marker located adjacent to (e.g., in front of or after) the text instance. The marker may be, for example, a box, a circle, a line, or any other shape used to designate a corresponding object on a chart. If a marker is detected, a color may then be detected at the boundaries of a bounding box of the text instance. The detected color may be designated as a background color. The algorithm may then determine whether the marker is a different color than the background color. If the marker is a different color than the background color, the text instance adjacent to the marker may be labeled as a legend. Because a legend may comprise multiple text instances and corresponding markers, this process may be repeated until all text instances corresponding to the legend are identified. Once all legend text has been identified, an additional validation step may be performed to ensure that all of the legends are aligned horizontally (e.g., having the same y-coordinates) and/or vertically (e.g., having the same x-coordinates) depending on the layout of the chart.

In some embodiments, the labeling algorithm may label a text instance as a chart title. The algorithm may search a top portion of the chart (e.g., the top 30% of the chart) for a text instance having the largest size (e.g., the largest font size). The text instance determined to have the largest size in the top portion of the chart may then be labeled as a chart title.

In some embodiments, the labeling algorithm may label one or more text instances as x-axis labels. The algorithm may search a bottom portion of the chart (e.g., the bottom 30% of the chart) for text instances which align vertically. Text instances that align vertically may have the same y-coordinates, such that they are located at the same longitude within the chart image. Text instances meeting these criteria may be labeled as x-axis labels.

In some embodiments, the labeling algorithm may label a text instance as an x-axis title. The algorithm may search a bottom portion of the chart (e.g., the bottom 30% of the chart) for a text instance within a predetermined distance of a center of the chart horizontally. For example, the algorithm may search for a text instance located within the middle 20% of the chart horizontally. A text instance meeting this criterion may be labeled as an x-axis title.

In some embodiments, the labeling algorithm may label one or more text instances as y-axis labels. The algorithm may search a left portion of the chart (e.g., the left 30% of the chart) for text instances which align horizontally. Text instances that align horizontally may have the same x-coordinates, such that they are located at the same latitude within the chart image. Text instances meeting these criteria may be labeled as y-axis labels.

In some embodiments, the labeling algorithm may label a text instance as a y-axis title. The algorithm may search a left portion of the chart (e.g., the left 30% of the chart) for a text instance within a predetermined distance of a center of the chart vertically. For example, the algorithm may search for a text instance located within the middle 20% of the chart vertically. A text instance meeting this criterion may be labeled as a y-axis title.

At step 214, a matching algorithm may be applied based on the one or more labeled text instances to match to text strings in a database. The matching algorithm may be applied directly to the labeled text instances and/or may be applied to one or more axis titles extracted or otherwise generated by a natural language processing model, as will be described in greater detail below. By matching the labeled text instances and/or extracted axis titles to text strings in the database, data which may be used to recreate the chart pictured in the original dashboard image may be identified. For example, if a labeled text instance or extracted axis title matches a text string corresponding to a column header in the database, the values underneath that column header may be used to populate the chart.

In some embodiments, a natural language processing model may optionally be applied to the labeled text instance labeled as a chart title prior to applying the matching algorithm. The natural language processing model may be configured to extract or otherwise generate one or both of the x-axis title and y-axis title from the chart title. Often, a chart title may take the form “y-axis vs. x-axis.” Thus, the natural language processing model may extract or otherwise generate both the x-axis title and y-axis title from the chart title based on an assumption that the chart title bears this form. As used herein, an “extracted axis title” can refer to an axis title that is extracted from or otherwise generated based on an analyzed input. For example, the natural language processing model may extract text corresponding to an axis title that literally appears in the chart title or may generate text corresponding to an axis title that does not literally appear in the chart title. In some embodiments, the natural language processing model may be an open-source natural language processing model (e.g., BERT) or may be a natural language processing model developed specifically for these purposes.

In some embodiments, a matching algorithm employing fuzzy string matching may be used to match the labeled text instances and/or extracted axis titles to text strings in a database. Fuzzy string matching, or approximate string matching, may be used to locate strings that approximately match (as opposed to strings that exactly match). In some embodiments, the fuzzy string matching technique used by the matching algorithm may use Levenshtein distances to match text instances and/or extracted axis titles to text strings in the database. The Levenshtein distance between two strings measures the difference between the strings based upon the number of single-character edits (e.g., insertions, deletions, or substitutions) that would be required to transform one string into the other. For example, the strings “cat” and “cut” have a Levenshtein distance of 1, since one substitution is required to turn the string “cat” into the string “cut” (i.e., replacing the letter “a” with the letter “u”).

The Levenshtein distance between two strings a and b, string a having a terminal character position of i (i.e., string a having i characters) and string b having a terminal character position of j (i.e., string b having j characters), may be calculated using the formula:

$$LD ( i , j ) = \{ \begin{matrix}\begin{matrix}max ( i , j ) & if min ( i , j ) = 0 \\ min \{ \begin{matrix}LD ( i - 1 , j ) + 1 \\ LD ( i , j - 1 ) + 1 \\ LD ( i - 1 , j - 1 ) + k\end{matrix} & otherwise\end{matrix} \\ where k = 0 if ( {a}_{i} = {b}_{j} ) , otherwise k = 1.\end{matrix} \qquad ( Equation 2 )$$

In some embodiments, multiple Levenshtein distances may be calculated for each labeled text instance and/or extracted axis title with respect to multiple text strings in the database. For each labeled text instance or extracted axis title, the smallest Levenshtein distance may correspond to the text string which matches the labeled text instance or extracted axis title most closely. A small Levenshtein distance indicates that few single-character edits are required to transform a first string into a second string.

In some embodiments, a matching algorithm may be applied to a labeled text instance labeled as an x-axis title or a y-axis title and/or to extracted/generated axis titles that have been extracted from or otherwise generated based on a chart title by a natural language processing model. In some embodiments, the matching algorithm may be applied to only the extracted/generated axis titles, to only the labeled text instances corresponding to the axis titles, or to both. The matching algorithm may be applied to extracted/generated axis titles in order to ensure the accuracy of the extracted axis titles, as the extractions made by the natural language processing model may be imperfect due to inaccuracies in the optical character recognition model's identification of the chart title in step 210. A matching algorithm configured to match a labeled text instance labeled as an x-axis title or an extracted/generated x-axis title to a text string in the database may calculate the Levenshtein distance between the x-axis title and each column header of a data table (e.g., a spreadsheet) in the database. Each Levenshtein distance represents the proximity of the match between the x-axis title and the column header. In some embodiments, the plurality of Levenshtein distances may be aggregated in a factorized manner. The matching algorithm may then match the x-axis title to the column header for which the corresponding Levenshtein distance is the smallest. In some embodiments, the data corresponding to the matching column header (e.g., the values listed under a column header) may be used to populate the chart. The same process may be followed to match a labeled text instance labeled as a y-axis title or an extracted/generated y-axis title to a text string in the database.

In some embodiments, a matching algorithm may be applied to labeled text instances labeled as x-axis labels or y-axis labels. To match labeled text instances labeled as x-axis labels to text strings in the database, the matching algorithm may aggregate the x-axis labels to form a text sentence of x-axis labels. A plurality of Levenshtein distances may then be generated between the text sentence of x-axis labels and text sentences generated by aggregating adjacent values beneath a given column header. For example, if the database has a column comprising the unique values “2020,” “2021,” “2022,” the unique values may be aggregated into a text sentence reading “2020 2021 2022,” and the Levenshtein distance between the text sentence from the database and the text sentence of x-axis labels may then be calculated. The plurality of Levenshtein distances generated by this process may be aggregated in a factorized manner. The matching algorithm may then match the text sentence of x-axis labels to a text sentence corresponding to data in a column for which the corresponding Levenshtein distance is the smallest. The same process may be repeated to matched labeled text instances labeled as y-axis labels to text strings in the database.

In some embodiments, a matching algorithm may be applied to a text instance labeled as a legend. To match a labeled text instance labeled as a legend to one or more text strings in the database, the matching algorithm may calculate the Levenshtein distance between the legend and the values listed under each column header of the data table. In some embodiments, the legend may comprise multiple text instances (e.g., a first text instance corresponding to a first unique value listed under a given column header and a second text instance corresponding to a second unique value listed under the same column header), in which case the legend may be matched to multiple text strings in the column. The Levenshtein distances may be aggregated in a factorized manner. The matching algorithm may then match the legend to the column header(s) for which the corresponding Levenshtein distance(s) are the smallest.

In some embodiments, a matching algorithm may be applied to a text instance labeled as a chart title. To match a labeled text instance labeled as a chart title to one or more text strings in the database, the matching algorithm may calculate the Levenshtein distance between the chart title and each column header of the data table. The Levenshtein distances may be aggregated in a factorized manner. The matching algorithm may then match the y-axis title to the column header for which the corresponding Levenshtein distance is the smallest. In some embodiments, the chart title may take the form “y-axis title vs. x-axis title.” In that case, the chart title may alternatively be determined based on the text strings matching the y-axis title and x-axis title. In some embodiments, the matching algorithm may not be applied to a text instance labeled as a chart title because there may not be an entry in the database corresponding to the chart title.

At step 216, instructions may be provided to a second dashboard platform to generate a second dashboard based on data corresponding to the text strings in the database. The instructions may be provided by dashboard generation engine 102. In some embodiments, the text strings in the database to which labeled text instances were matched in step 214 are used to identify data to be used to populate the second dashboard. For example, a text string in the database corresponding to an x-axis title may be a column header. The data beneath the column header in the corresponding column may therefore correspond to x-values in the chart to be recreated.

In some embodiments, the instructions may include information about the layout, data, and visualization of the chart to be recreated. The instructions may include the chart type identified by the classification model (e.g., bar chart, line chart, pie chart). The instructions may further include the coordinates of the chart within the original image of the first dashboard, such that the spatial layout of the first dashboard may be recreated. The instructions may further include the text instances generated from the image (e.g., the chart title, axis titles, axis labels, and/or legend), the text strings from the database to which the text instances were matched, or a combination thereof. The instructions may also include any data corresponding to the text strings (e.g., values in a data table corresponding to a column header which matched a labeled text instance and/or extracted axis title) which may be used to populate a chart in the second dashboard. The instructions may further include visualization details. In some embodiments, the instructions may be provided in JSON.

In some embodiments, the instructions may be provided directly from dashboard generation engine 102 to a dashboard platform (e.g., dashboard platform 116 described above with reference to FIG. 1), which can create a dashboard based on the instructions. The dashboard may be generated using a dashboard platform that is different from the dashboard platform used to generate the dashboard pictured in the image received at step 202. The second dashboard platform may be, for example, Tableau or PowerBI.

In some embodiments, the instructions may alternatively or additionally be provided from dashboard generation engine 102 to a user via a user system (e.g., user system 108 described above with reference to FIG. 1). The user may then determine any downstream uses for the instructions. For example, the user may provide the instructions to a dashboard generation platform or may store the instructions to be used at a later time.

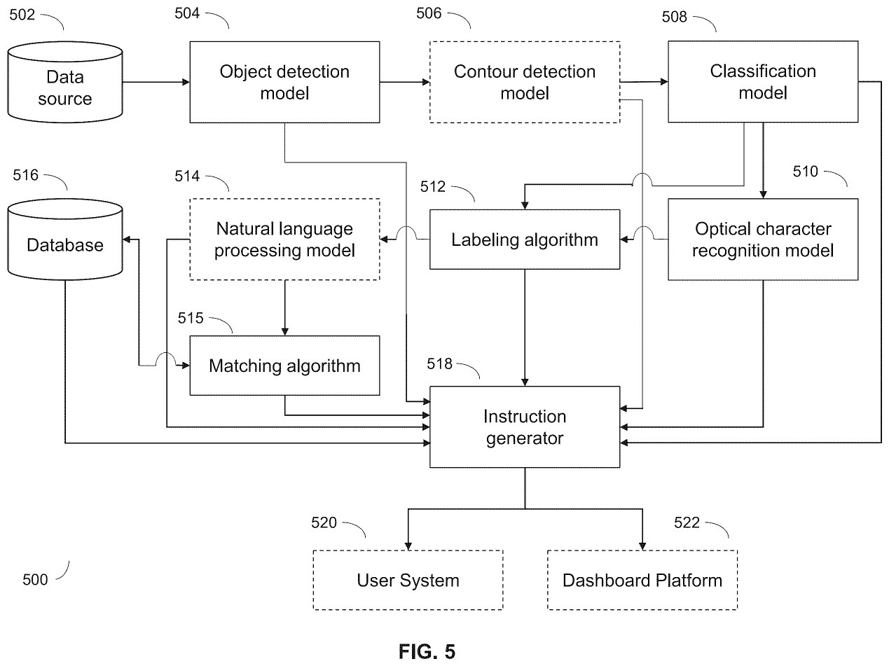

FIG. 5 illustrates an exemplary flowchart 500 depicting a process for generating a dashboard from an image, such as system 100 described above with reference to FIG. 1. The boxes depicted in FIG. 5 may represent various models, algorithms, and/or functional components included in system 100. In some embodiments, one or more boxes may correspond to functional components of the system (e.g., data source 502). In some embodiments, one or more boxes may correspond to computer programs (e.g., object detection model 504), which may be run on their own computing systems or on a shared computing system with other programs.

A process for generating a dashboard from an image may begin with obtaining an image of a dashboard generated using a first dashboard platform from data source 502. As described above with reference to FIG. 1, data source 502 may be or may include a memory, a computer program, or a server or database for storing images. The images may be stored as JPEG files, PNG files, PDF files, or any other suitable file format. The images may depict a dashboard created using a dashboard platform such as Tableau or PowerBI.

Data source 502 may provide the image of the dashboard to an object detection model 504. Object detection model 504 may be implemented as software on its own computing device or may be implemented on a computing device with one or more other programs. Object detection model 504 may be configured to detect one or more charts in the image of the dashboard provided by data source 502 and provide the coordinates of the one or more charts. Object detection model 504 may be an open-source object detection model or may be specifically developed for these purposes.

Once charts in the image have been detected using object detection model 504, the image may optionally be passed to a contour detection model 506, which may identify the precise contours of each chart detected by object detection model 504. Contour detection model 506 may be implemented as software on its own computing device or may be implemented on a computing device with one or more other programs. Based on the assumption that most charts are rectangular and can be enclosed within a rectangular bounding box, contour detection model 506 may identify a rectangular boundary for each detected chart. The rectangular boundary may enclose the chart and isolate the chart from other features of the dashboard image (e.g., text, graphical user interface menu objects, etc.). Accurately identifying the contours of each chart may improve the performance of one or more downstream models (e.g., classification model 508). Contour detection model 506 may be an open-source contour detection model or may be a model developed specifically for these purposes.

The output from contour detection model 506 may include one or more portions of a dashboard image depicting charts with rectangular boundaries. The output may be provided to a classification model 508. Classification model 508 may be implemented as software on its own computing device or may be implemented on a computing device with one or more other programs. Classification model 508 may be configured to classify the one or more charts detected in the image by type. For example, a chart may be classified as a line chart, a bar chart, or a pie chart. Classification model 508 may be an open-source classification model or may be a model specifically developed for these purposes.

The output of classification model 508 may be provided to an optical character recognition model 510. Optical character recognition model 510 may be implemented as software on its own computing device or may be implemented on a computing device with one or more other programs. Optical character recognition model 510 may be configured to generate textual information from the one or more charts detected in the image. Optical character recognition model 510 may generate both horizontally and vertically oriented text instances and may identify the coordinates of each generated text instance. As described above with reference to FIG. 2, optical character recognition model 510 may be configured to detect text from the image in multiple orientations and generate corresponding text instances. For example, optical character recognition model 510 may be applied to the image in its default orientation to generate horizontal text instances and then applied again when the image is rotated 90 degrees to generate vertical text instances. In some embodiments, the text instances generated by optical character recognition model 510 may be further processed to ensure that duplicate text instances are not generated. For example, the intersection over union (IoU) may be calculated between each pair of text instances comprising a text instance generated from an image in a horizontal orientation and a text instance generated from the image in a vertical orientation. If the IoU exceeds a predetermined threshold value, the aspect ratios of the pair of text instances may be compared to determine which text instance to keep and which to discard.

The output from optical character recognition model 510 may be provided to a labeling algorithm 512, which may be configured to label the text instances generated by optical character recognition model 510. Labeling algorithm 512 may be implemented as software on its own computing device or may be implemented on a computing device with one or more other programs. Labeling algorithm 512 may apply various rules to the generated text instances to label them as chart titles, legends, x or y axis titles, or x or y axis labels. The rules are described in detail above with reference to FIG. 2. Labeling algorithm 512 may also receive the classification of each chart type from classification model 508. The type of chart from which the generated text instances originate can inform which labels need to be assigned. For example, if a chart is classified as a pie chart by classification model 508, labeling algorithm 512 need only label text instances corresponding to a chart title and legend, since pie charts do not have x or y axes.

One or more labeled text instances produced by labeling algorithm 512 may optionally be provided to natural language processing model 514. Natural language processing model 514 may be implemented as software on its own computing device or may be implemented on a computing device with one or more other programs. In some embodiments, natural language processing model 514 may be configured to receive only the labeled text instance labeled as a chart title from labeling algorithm 512. Natural language processing model 514 may be configured to extract or otherwise generate one or both of the x-axis title and y-axis title from the labeled text instance labeled as a chart title. The x-axis title and/or y-axis title extracted or generated by natural language processing model 514 may then be compared to text strings (e.g., column headers) in database 516 by matching algorithm 515 in order to identify data which can be used to recreate the dashboard. Database 516 may include the data used to create the dashboard pictured in the original image received from data source 502.

The labeled text instances produced by labeling algorithm 512 may also be provided to a matching algorithm 515. Matching algorithm 515 may be configured to match the labeled text instances (and the extracted/generated axis titles received from natural language processing model 514) to text strings in database 516. Matching algorithm 515 may be implemented as software on its own computing device or may be implemented on a computing device with one or more other programs. Matching algorithm 515 may use fuzzy matching techniques (e.g., Levenshtein distances) to match labeled text instances and/or extracted axis titles to column headers in a data table included in database 516. Data corresponding to the matching column headers (e.g., values underneath a given column header) may be used to recreate the dashboard pictured in the original image received from data source 102.

The matches generated by matching algorithm 515 may be provided to an instruction generator 518. Instruction generator 518 may also receive chart coordinates from object detection model 504 and/or contour detection model 506, chart classification information from classification model 508, coordinates of text instances from optical character recognition model 510, labeled text instances from labeling algorithm 512, axis titles from natural language processing model 514, and/or data from database 516. Based on the information received, instruction generator 518 may generate instructions for creating a dashboard using a second dashboard program that is different from the first dashboard program used to create the dashboard pictured in the image received from data source 502. As described in detail with reference to FIG. 2, the instructions may include information about the layout, data, and visualization elements of the dashboard to be created. Instruction generator 518 may be provided as software on its own computing system or may be implemented on a computing device with one or more other programs. In some embodiments, instruction generator 518 may be integrated into dashboard generation engine 102.

The instructions produced by instruction generator 518 may optionally be provided to a user system 520. User system 520 may include a user interface through which a user may view the instructions and determine one or more subsequent actions to be taken. For example, a user may choose to store the instructions (e.g., in a memory of the user system) or transmit the instructions to a dashboard platform in order to create a live dashboard.

The instructions produced by instruction generator 518 may optionally be provided to a dashboard platform 522 instead of or in addition to user system 520. Dashboard platform 522 may be Tableau, PowerBI, or any other suitable program for creating dashboards.

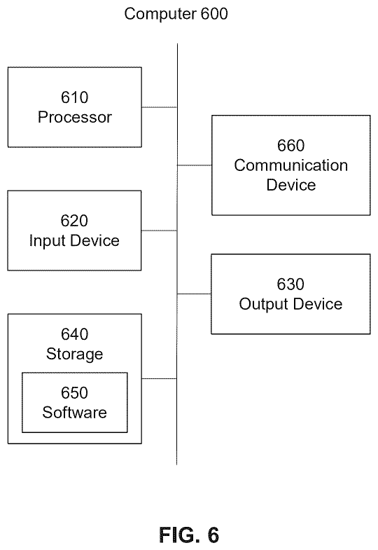

In one or more examples, the disclosed systems and methods utilize or may include a computer system. FIG. 6 illustrates an exemplary computing system according to one or more examples of the disclosure. Computer 600 can be a host computer connected to a network. Computer 600 can be a client computer or a server. As shown in FIG. 6, computer 600 can be any suitable type of microprocessor-based device, such as a personal computer, workstation, server, or handheld computing device, such as a phone or tablet. The computer can include, for example, one or more of processor 610, input device 620, output device 630, storage 640, and communication device 660. Input device 620 and output device 630 can correspond to those described above and can either be connectable or integrated with the computer.

Input device 620 can be any suitable device that provides input, such as a touch screen or monitor, keyboard, mouse, or voice-recognition device. Output device 630 can be any suitable device that provides an output, such as a touch screen, monitor, printer, disk drive, or speaker.

Storage 640 can be any suitable device that provides storage, such as an electrical, magnetic, or optical memory, including a random-access memory (RAM), cache, hard drive, CD-ROM drive, tape drive, or removable storage disk. Communication device 660 can include any suitable device capable of transmitting and receiving signals over a network, such as a network interface chip or card. The components of the computer can be connected in any suitable manner, such as via a physical bus or wirelessly. Storage 640 can be a non-transitory computer-readable storage medium comprising one or more programs, which, when executed by one or more processors, such as processor 610, cause the one or more processors to execute methods described herein.

Software 650, which can be stored in storage 640 and executed by processor 610, can include, for example, the programming that embodies the functionality of the present disclosure (e.g., as embodied in the systems, computers, servers, and/or devices as described above). In one or more examples, software 650 can include a combination of servers such as application servers and database servers.

Software 650 can also be stored and/or transported within any computer-readable storage medium for use by or in connection with an instruction execution system, apparatus, or device, such as those detailed above, that can fetch and execute instructions associated with the software from the instruction execution system, apparatus, or device. In the context of this disclosure, a computer-readable storage medium can be any medium, such as storage 640, that can contain or store programming for use by or in connection with an instruction execution system, apparatus, or device.

Software 650 can also be propagated within any transport medium for use by or in connection with an instruction execution system, apparatus, or device, such as those described above, that can fetch and execute instructions associated with the software from the instruction execution system, apparatus, or device. In the context of this disclosure, a transport medium can be any medium that can communicate, propagate, or transport programming for use by or in connection with an instruction execution system, apparatus, or device. The transport-readable medium can include but is not limited to, an electronic, magnetic, optical, electromagnetic, or infrared wired or wireless propagation medium.

Computer 600 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Computer 600 can implement any operating system suitable for operating on the network. Software 650 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

The foregoing description, for the purpose of explanation, has been described with reference to specific embodiments and/or examples. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

1. A method for generating a dashboard from an image, the method comprising:
receiving an image of at least part of a first dashboard generated using a first dashboard platform;
applying an object detection model to the image to detect a chart in the image;
extracting a portion of the image comprising the chart;
applying a classification model to the extracted portion of the image to classify the chart;
applying an optical character recognition model to the extracted portion of the image to generate one or more text instances based on the extracted portion;
labeling the one or more text instances;
applying a matching algorithm based on the one or more labeled text instances to match to text strings in a database; and
providing instructions for a second dashboard platform to generate a second dashboard based on data corresponding to the text strings in the database.

2. The method of claim 1, wherein extracting a portion of the image comprising the chart comprises:
applying a contour detection model to the image to detect a boundary of the chart; and
extracting a portion of the image comprising an area surrounded by the detected boundary.

3. The method of claim 2, wherein the contour detection model is configured to detect a rectangular boundary around the chart.

4. The method of claim 1, wherein applying the matching algorithm based on the one or more labeled text instances comprises applying the matching algorithm to the one or more labeled text instances.

5. The method of claim 1, wherein applying the matching algorithm based on the one or more labeled text instances comprises:
applying a natural language processing model to a labeled text instance labeled as a chart title;
receiving, from the natural language processing model, a first extracted text instance corresponding to an x-axis title extracted from the chart title and a second extracted text instance corresponding to a y-axis title extracted from the chart title; and
applying the matching algorithm to at least the first extracted text instance and the second extracted text instance.

6. The method of claim 5, further comprising:
applying the matching algorithm to one or more additional labeled text instances.

7. The method of claim 1, wherein the matching algorithm is configured to:
receive an input comprising a labeled text instance or an extracted axis title;
calculate, for the input, a plurality of scores, wherein each score indicates a proximity of a match between the input and a respective text string in the database;
select a lowest score; and
match the input to a first text string corresponding to the lowest score.

8. The method of claim 7, wherein the plurality of scores comprise Levenshtein distances.

9. The method of claim 1, wherein the image comprises a PNG, JPEG, or PDF file.

10. The method of claim 1, wherein the first dashboard comprises data from the database.

11. The method of claim 1, wherein the object detection model is configured to detect coordinates of the chart.

12. The method of claim 1, wherein the object detection model is trained using a plurality of charts comprising a plurality of chart types.

13. The method of claim 1, wherein the classification model is configured to classify the chart as a bar chart, line chart, pie chart, scatter chart, or area chart.

14. The method of claim 1, wherein the optical character recognition model is configured to generate text comprising at least one of a chart title, a chart legend, x-axis labels, an x-axis title, y-axis labels, or a y-axis title.

15. The method of claim 14, wherein the optical character recognition model is configured to identify coordinates of the generated text.

16. The method of claim 1, wherein labeling the one or more text instances comprises:
detecting text instances in a top portion of the extracted portion of the image;
determining a size of each text instance in the top portion;
identifying a first text instance having a largest size in the top portion; and
labeling the first text instance as a chart title.

17. The method of claim 16, wherein the top portion comprises an upper 30% of the portion of the image.

18. The method of claim 1, wherein labeling the one or more text instances comprises:
detecting a marker located adjacent to a first text instance;
determining that the marker is a different color than a background color of the extracted portion of the image; and
labeling the first text instance as a legend.

19. The method of claim 1, wherein labeling the one or more text instances comprises:
detecting a first plurality of text instances in a bottom portion of the extracted portion of the image;
determining that the first plurality of text instances are vertically aligned; and
labeling the first plurality of text instances as x-axis labels.

20. The method of claim 1, wherein labeling the one or more text instances comprises:
detecting a first text instance in a bottom portion of the extracted portion of the image;
determining that the first text instance is within a predetermined distance of a center of the extracted portion of the image horizontally; and
labeling the first text instance as an x-axis title.

21. The method of claim 20, wherein the bottom portion comprises a bottom 30% of the portion of the image.

22. The method of claim 1, wherein labeling the one or more text instances comprises:
detecting a first plurality of text instances in a left portion of the extracted portion of the image;
determining that the first plurality of text instances are horizontally aligned; and
labeling the first plurality of text instances as y-axis labels.

23. The method of claim 1, wherein labeling the one or more text instances comprises:
detecting a first text instance in a left portion of the extracted portion of the image;
determining that the first text instance is within a predetermined distance of a center of the extracted portion of the image vertically; and
labeling the first text instance as a y-axis title.

24. The method of claim 23, wherein the left portion comprises a left 30% of the portion of the image.

25. A system for generating a dashboard from an image, the system comprising one or more processors configured to cause the system to perform a method comprising:
receiving an image of at least part of a first dashboard generated using a first dashboard platform;
applying an object detection model to the image to detect a chart in the image;
extracting a portion of the image comprising the chart;
applying a classification model to the extracted portion of the image to classify the chart;
applying an optical character recognition model to the extracted portion of the image to generate one or more text instances based on the extracted portion;
labeling the one or more text instances;
applying a matching algorithm based on the one or more labeled text instances to match to text strings in a database; and
providing instructions for a second dashboard platform to generate a second dashboard based on data corresponding to the text strings in the database.

26. A non-transitory computer-readable storage medium storing instructions that, when executed by one or more processors of an electronic device, cause the device to perform a method comprising:
receiving an image of at least part of a first dashboard generated using a first dashboard platform;
applying an object detection model to the image to detect a chart in the image;
extracting a portion of the image comprising the chart;
applying a classification model to the extracted portion of the image to classify the chart;
applying an optical character recognition model to the extracted portion of the image to generate one or more text instances based on the extracted portion;
labeling the one or more text instances;
applying a matching algorithm based on the one or more labeled text instances to match to text strings in a database; and
providing instructions for a second dashboard platform to generate a second dashboard based on data corresponding to the text strings in the database.
